(19) United States
(12) Patent Application Publication
(10) Pub. No.: US 2022/0306398 A1
(43) Pub. Date: Sep. 29, 2022

(54) APPARATUS AND METHOD FOR CONVEYING AND SORTING ARTICLES

(71) Applicant: Siemens Aktiengesellschaft, Muenchen (DE)

(72) Inventor: Peter Enenkel, Konstanz (DE)

(21) Appl. No.: 17/638,320

(22) PCT Filed: Aug. 18, 2020
(86) PCT No.: PCT/EP2020/073112

§ 371 Date: Feb. 25, 2022

(30) Foreign Application Priority Data
Aug. 26, 2019 (EP) 19193622.8
Apr. 8, 2020 (EP) 20168605.2

(51) Int. Cl. B65G 43/08; B07C 3/08; B65G 47/84

(52) U.S. Cl. CPC B65G 43/08; B07C 3/08; B65G 47/844; B65G 2203/0283

(57) ABSTRACT

An apparatus and a method convey and sort articles. The apparatus contains a link conveyor, having link elements, pushing-off elements, drive elements, and a control device. The link conveyor runs along a belt-movement line and has along the belt-movement line the link elements which are arranged to follow one after the other and form a conveying surface for the articles. In each case one pushing-off element can be arranged on one of the link elements, above the conveying surface, and therefore the pushing-off element runs along the belt-movement line together with the link element, and the pushing-off element can be moved, and stopped, along a pushing-off-line, which is arranged transversely to the belt-movement line. The drive elements each drive one or more pushing-off elements individually, and therefore the operations of moving and stopping these pushing-off elements, which are arranged to follow one after the other, are independent of one another.

The present invention relates to the technical field of a conveying apparatus for sorting articles.

Due to the great increase in mail order business, there has been a great increase, in the mixed mail domain, in the volume of goods being sent overall and in sent items of different sizes since, through the growth in automated shipment, there is ever less consolidation of shipped goods. It is estimated that the rate of growth in the volume of small goods shipments in the next few years will be over 20 percent per annum. This involves essentially B2C E-commerce packages with very heterogeneous and non-storage stable packages. Overall, the proportion thereof in the volume of articles is predicted to be more than 50 percent. These small goods shipments are often poorly packaged (with a mobile center of gravity inside the packaging, delicate packaging material, etc.) so that rough handling increases the risk of damage to the article, its packaging and the conveying apparatus.

An efficient, gentle and—for the avoidance of the expansion of existing sorting centers—as far as possible, space-saving implementation of sorting processes is of great importance for the efficiency and reliability of the overall shipping chain.

A known sorting system which enables safe handover of non-homogeneous goods to terminals by positive mounting is the shoe sorter. Existing shoe sorters have conventionally been purely linear sorters with a return run on the underside and are neither three-dimensionally nor curve-capable. The number of terminals is therefore very limited.

A typical shoe sorter comprises a circulating conveyor belt which has segments arranged behind one another in a main conveying direction. Shoe sorters are linear conveyors. Movably mounted on each segment perpendicularly to the main conveying direction in order to divert goods laterally is a slot-guided pushing-off element (“shoe”). A track guidance arrangement arranged under the conveyor belt within the conveyor frame guides the pushing-off elements from one side to the other side over the conveyor belt when the conveyor belt is driven in the conveying direction. For this purpose, the pushing-off elements have pins under the conveying surface which are threaded into the track guidance arrangement in a points-like manner. The pushing-off elements are themselves driven by the conveyor belt and the sent item length determines how many pushing-off elements are deflected in a points-like manner by the track guidance arrangement. Shoes arranged behind one another therefore move in single file behind one another diagonally in order to eject one item laterally. For each terminal a track guidance arrangement is needed.

Alternatively, it is also possible to realize smaller segments and pushing-off elements and to provide a plurality of track guidance arrangements per terminal so that all the pushing-off elements assigned to a terminal are moved perpendicularly simultaneously, so that no rotation of the item to be ejected occurs. For each terminal, there must therefore be a plurality of track guidance arrangements.

In the process of automating the sorting processes, a complete automation of the process to as many terminals as possible (one touch) is striven for. If, for this purpose, a multistage or sequential and therefore throughput-reducing sorting process is to be avoided, it must be possible to realize very many terminals in the smallest possible space. However, this also can only be achieved with systems which enable an arrangement of the terminals and of the conveying technology over a plurality of levels on a small area and are therefore three-dimensionally capable.

The existing solutions are inflexible since the manner and number of the track guidance arrangement determines the number of terminals. Thus, the number of terminals cannot be flexibly adapted to a specific sorting situation. The pushing-off elements of shoe sorters can only be moved constantly from one side of the conveyor belt to the other.

The movements of the shoes of pin-controlled shoe sorters can only be triggered at particular points and stopping of a shoe in the middle of the conveying surface is not possible. Conveyors with separately controllable conveying segments (roller conveyors or similar) are not suitable for small goods shipments since, by reason of their inhomogeneity, these do not lie sufficiently evenly on the conveying surface to be moved in a controlled manner.

It is therefore an object of the present invention to provide an improved conveying and sorting apparatus. This object is achieved by an apparatus and a method having the features of the independent claims.

The solution according to the invention relates to an apparatus for conveying and sorting articles, comprising a link conveyor which has link elements, pushing-off elements and drive elements, and a control device. The link conveyor is equipped to run along a belt movement line and has link elements arranged sequentially one after the other along the belt movement line forming a conveying surface for the articles. A pushing-off element can be arranged on each of the link elements above the conveying surface so that the pushing-off element runs together with the link element along the belt movement line and said pushing-off element can be moved and stopped along a pushing-off line which is arranged on the link element at an angle, in particular substantially perpendicularly to the belt movement line between a first and a second side of the link element. The drive elements are each configured to drive one or more pushing-off elements individually, wherein at least two pushing-off elements arranged one after the other along the belt movement line can be driven by different drive elements so that the movement and stopping of these pushing-off elements arranged one after the other is independent of one another. The control device is configured for controlling the running of the link conveyor and of the drive elements.

Advantageous embodiments of the invention are contained in the subclaims.

An arrangement of the pushing-off element above the conveying surface should be understood as meaning that the part of the pushing-off element coming into contact with the article is arranged above the conveying surface, and an extension below the conveying surface for guiding, for driving and/or for attaching the pushing-off element is naturally possible.

The link elements each extend over a width of the link conveyor. The belt movement line defines the conveying path of the link conveyor. If the link conveyor is a purely linear conveyor without curves, only one transport direction is involved, but otherwise a plurality thereof.

The pushing-off element which can be moved along the width of the link conveyor between the first and the second side of the link element can be moved in a rail-like manner along the pushing-off line of its associated link element. In a purely linear conveyor, with similar link elements all the pushing-off lines are therefore parallel to one another and in the case of curve-shaped link conveyors, the pushing-off line and the belt movement line are typically tangential to one another.

If the link conveyor runs along the belt movement line, the link elements run together with their pushing-off elements and drive elements, wherein a driving of a drive element brings about a driving of the associated pushing-off element and thus, in addition to their movement along the belt movement line, the pushing-off elements can be moved along their pushing-off line.

The individual pushing-off elements can be stopped at any position along their pushing-off line on the link element in an individually controlled manner. Successive pushing-off elements can be controlled individually. The drive elements can be controlled with one or more autonomously controllable drives, although typically, one drive element drives only one link element. The control device is also equipped to control all the elements of the apparatus.

The pushing-off elements can selectively be moved autonomously and individually and any desired slot can be traversed. The pushing-off elements can be moved grouped together or individually so that the movement sequence can be determined in a completely individualized manner. The link conveyor can traverse curves in which the articles can also be ejected, and can also be height-adjusted. The height-adjustment capability enables transport over a plurality of levels and therefore utilizes less area without lifts, escalators or similar being required.

The solution according to the invention can be further improved by means of different embodiments, each per se advantageous and, provided not otherwise stated, freely combinable with one another. These embodiments and the advantages associated with them are considered below.

According to one embodiment, the link elements can be mounted on a guide rail arranged between their first and second side, preferably substantially centrally or can be mounted laterally on two guide rails arranged along the belt movement direction. A middle or central arrangement extends along the belt movement line.

In the case of curves of the link conveyor, in order to achieve a continuous conveying surface without gaps, link elements arranged sequentially following one another can be arranged behind one another and/or overlapping one another slidingly, in particular in the manner of scarf joints and/or intermeshingly. With a scarf joint-like tapering of the link elements in an acute angle, the conveying surface can be realized, including on overlapping of the link elements, even in curves to be relatively even and with only very slight interfering contours. In order to enable a sliding overlap, curved motion or conveyor belt loop-like circulation of the link elements, adjacent link elements are provided without fixing their contact surfaces to one another.

According to one embodiment, the pushing-off elements and the link elements can be configured to engage with one another with groove guidance and/or with gripping guidance. By this means, in particular by combination, a more stable embodiment of the link conveyor and an increased stability of the conveying surface is achieved, which is relevant in particular for long link elements and pushing-off elements and for heavy articles. With a groove guidance, the link element has a slot along the pushing-off line for inserting and guiding the pushing-off element. In the case of a gripping guidance, the pushing-off element laterally surrounds its link element entirely or partially.

In order also to enable a high degree of flexibility in movement and positioning of the pushing-off elements with articles lying on the relevant link elements, the pushing-off elements can be configured so they can be lowered to the height of, or below, the conveying surface. This can be achieved in a simple manner by means of a circulation of the pushing-off elements on their link elements above and below the conveying surface.

The drive elements can be configured as linear drives, preferably comprising a spindle which is designed during its rotation to move the pushing-off element along the pushing-off line of the link element. Herein, the pushing-off element can be configured as a rotor on the linear drive or motor, wherein the linear motor can act as a rail arranged along the pushing-off line for the pushing-off element. The drive type is not restricted to a linear drive, rather many other drive types are possible, such as a screw-powered ball-screw drive, roller-screw drive with roller return, planetary roller screw drive, acme screw drive, quick-acting screw drive, hydrostatic screw drive, linear motor, pneumatic cylinder, hydraulic cylinder, rack and pinion drive, cable loop, cam disk, etc.

So that the pushing-off elements remain at their stopped position even at full travel and/or with heavy articles, the pushing-off elements can be configured to be lockable.

A coordinated locking of a plurality of pushing-off elements positioned round an article clamps this article during the transport of the link conveyor, so that no undesirable position changes of the article or of the pushing-off elements themselves occur even by slipping, gliding, or the like. This is relevant particularly for travel along curves.

According to one embodiment, the control device can be configured to control the apparatus, in particular, the pushing-off elements, in response to the position and movement of the link elements, the pushing-off elements and the articles.

With regard to a method, the aforementioned object is achieved with a method for conveying and sorting articles, comprising the method steps:

Placement of an article on one or more link elements of a link conveyor arranged one after the other along a belt movement line and forming a conveying surface for the articles, wherein a pushing-off element can be arranged above the conveying surface on each link element.

Movement of the link conveyor along the belt movement line. Individually controlled movement and stopping of one or more pushing-off elements along each pushing-off line, wherein the pushing-off line on the respective link element is arranged at an angle, in particular substantially perpendicularly to the belt movement line between a first and a second side of the link element and wherein at least two pushing-off elements arranged one behind the other along the belt movement line can be controlled independently of one another.

The pushing-off elements are moved in order to push an article along the pushing-off line in order to preposition the pushing-off elements in expectation of an article to be placed on the link conveyor and/or in order to move one or more pushing-off elements to an article already lying on the conveying surface of the link conveyor. The movement of a pushing-off element can be stopped along the whole of the pushing-off line.

The method has the same advantages, where they are transferrable, that are set out with regard to the method described.

According to one embodiment, the method can also comprise the following method steps. Acquisition of the position and/or shape of the article on the conveying surface. Control of the running of the link conveyor along the belt movement line and/or the movement and stopping of the pushing-off elements in response to the acquired position and/or shape of the article. It is thus possible to react flexibly to the loading of the link conveyor without the exact positioning, dimensions, etc. of the articles having to be known in advance and it is possible to react flexibly to unexpected position changes.

According to a further embodiment, the stopping of one or more pushing-off elements can take place provided the article is still lying on the link element or elements of this or these pushing-off elements. This enables the surrounding of an article during the transport and/or the prepositioning of an article on the conveying surface before a final pushing-off from the link conveyor. In this way, very many higher ejection speeds can be achieved while simultaneously protecting articles.

According to a further embodiment, a contrary motion of the pushing-off elements of successively arranged link elements to an article lying on these link elements and stopping of these pushing-off elements can take place so that an article is subsequently restricted in its movement by these pushing-off elements.

In order to position or orient an article on the conveying surface and/or to eject it from the link conveyor, a movement of an article along the pushing-off line by one or more pushing-off elements can take place. The more pushing-off elements that are in contact with an article, that is, the smaller the subdivision of the link conveyor or the smaller the pushing-off elements and the width of the link elements in relation to the article, the more accurately an article can be oriented and positioned and the more stably an article can be clamped.

According to a further embodiment, a locking of a pushing-off element can take place. The locking takes place after the stopping of this one pushing-off element. A locked pushing-off element acts as a stopper and when pushing-off elements surrounding an article are locked, they clamp this article firmly.

According to a further embodiment, a lowering of a pushing-off element to the height of, or below, the conveying surface can take place. Thus an article previously clamped by a plurality of pushing-off elements can be pushed off unhindered on that side on which the pushing-off element is lowered even if a pushing-off element was previously positioned on this very side. Or, an article can be surrounded by a plurality of pushing-off elements even if previously, with the article already lying on the conveying surface, all the pushing-off elements were arranged on one side.

Embodiments of the invention will now be described below in greater detail, making reference to the drawings, in which:

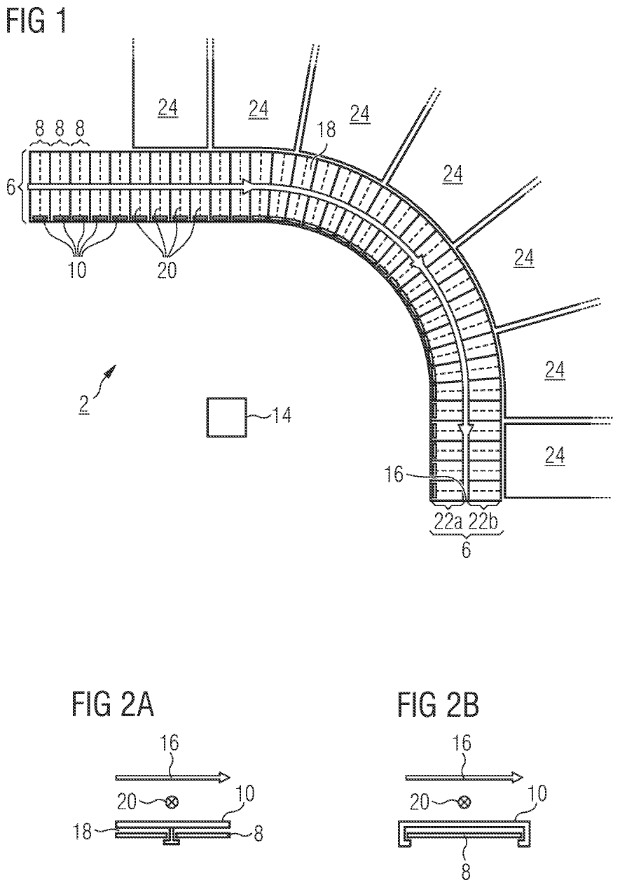

FIG. 1 shows an apparatus with terminals and a link conveyor having a curve;

FIG. 2 shows guidance possibilities for the pushing-off elements;

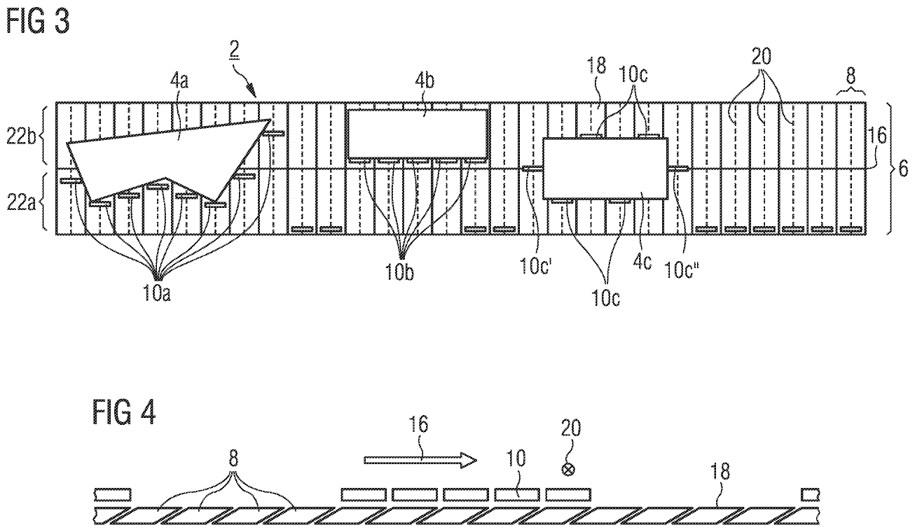

FIG. 3 shows articles lying on a link conveyor with respectively differently positioned pushing-off elements; and

FIG. 4 shows link elements configured in a scarf joint-like manner in cross-section.

FIG. 1 shows, in plan view, an apparatus 2 for conveying and sorting articles 4 (not shown in FIG. 1). The apparatus 2 comprises a link conveyor 6 with a belt movement line 16 defining a curve as the main transport direction and comprising link elements 8, arranged following one another along the belt movement line 16, which form a conveying surface 18. The link elements 8 overlap one another so that they can slide over one another in curves. Rather than overlapping one another, the link elements 8 can also otherwise engage in one another.

Therefore, the link conveyor 6 can move along curves, twists and slopes without gaps arising on the conveying surface 18 through which the articles 4 or other small parts can fall or which represent interfering contours.

Each link element 8 has a pushing-off line 20 and its own pushing-off element 10 arranged on this link element 8. The pushing-off elements 10 are driven by autonomously controllable drive elements 12 associated with them and can be moved, stopped and preferably also locked in an individually controlled manner on the link element 8 between their two sides 22a, 22b along their pushing-off line 20. An autonomous controllability should be understood to mean that all the pushing-off elements 10 or at least pushing-off elements arranged following one another along the belt movement line 16 can be moved and stopped independently of one another. Preferably, for this purpose, each pushing-off element 10 has its own drive element 12.

The pushing-off elements 10 can thus be moved, stopped and preferably also locked both at any position along the pushing-off line 20 and also completely independently of one another. The movement possibilities of the pushing-off elements 10 are not restricted to particular points along the belt movement line 16. A high level of flexibility is therefore possible. A plurality of pushing-off elements 10a can be positioned adapted to the contours of an article 4a (FIG. 3), can orient this article 4 and subsequently or simultaneously move it along the pushing-off line 20. Articles can also be ejected and/or manipulated in curves of the link conveyor 6. In contrast to other sorting systems, the spacing between successive articles 4 is independent of the article size and can be selected individually. It is possible firstly to preposition an article 4 during transport along the belt movement line 16 with the pushing-off elements 10 (to the edge of the conveying surface 18 like the article 4b in FIG. 3 and/or usefully with regard to its orientation, as in the example of the article 4a in FIG. 3), then the pushing-off elements 10 are stopped and possibly also locked before the article 4 is ejected laterally by the pushing-off elements 10 into one of the terminals 24 directly adjoining the link conveyor 6. In order to eject the prepositioned article 4, all the pushing-off elements 10 in contact with this article 4 are moved simultaneously and in a coordinated manner. By means of the prepositioning, higher ejection speeds are possible, but with very precise and article-protecting removal, since the prepositioned article must only be accelerated and moved over a short path. Individually or in combination, all of this enables the apparatus 2 to have a particularly high capacity.

The alignment of the link elements 8 determines the angle between the pushing-off line 20 and the belt movement line 16. In FIG. 1, these are arranged substantially perpendicularly to one another, but other angles (which preferably agree for all the link elements 8) are also possible.

The apparatus 2 comprises a control device 14 for driving the link conveyor 6, the pushing-off elements 10 and their drive elements 12. According to a preferred embodiment, the apparatus 2 also has locking apparatuses for locking stopped pushing-off elements 10. The locking apparatuses can be included by the drive elements 12 or can be configured separately. In the case of a drive element 12 configured as a spindle, the locking can be realized particularly simply. For realizing the drive elements 12, a wide variety of drive possibilities can be accessed. It is decisive only that the selected drives are configured for individually driving and stopping the movement of the pushing-off elements 10 on their link elements 8, wherein the stopping should preferably be possible at any position along the pushing-off line 20. The most precise possible controllability is advantageous, as is a rapid acceleration so that the pushing-off elements 10 can also eject precisely even at high speeds of the link conveyor 6. The drive elements 12 must be able to move along the belt movement line 16 together with their link elements 8. Preferably, each pushing-off element 10 has its own drive element 12. At the outside it is still possible that a drive element 12 controls a plurality of pushing-off elements 10 situated relatively close to one another, wherein at least two pushing-off elements 10 arranged behind one another along the belt movement line 16 can be driven by different drive elements 12.

According to a further embodiment, the control device 14 is also configured to detect the position and orientation of the articles 4 on the apparatus 2 both with a detection apparatus and/or using calculations with a known start position and orientation on the apparatus 2 and in response thereto, to control the apparatus 2. The position of the pushing-off elements 10 must also be known to the control device 14 (comprehensible either on the basis of calculations and/or detectors) and/or on the basis of feedback. The control device 14 knows selected reference points for a determination of the ejection positions.

The link conveyor 6 runs on a guideway which is configured, in particular, in a rail-like manner. According to a further embodiment, the link conveyor 6 is held by a central guideway arranged in the middle, substantially along the belt movement line 16. Thus, folds and bends of the link conveyor 6, curves etc. are particularly simple to realize by design. Other guideways are possible, for example, a railway track-like guide on both sides.

According to a further embodiment, a separating apparatus for separating the articles 4 is arranged upstream of the apparatus 2, so that two articles 4 are not situated on one link element 8 simultaneously.

The dimensioning of the link elements 8 and the pushing-off elements 10 in relation to the articles 4 determines the possible precision in the case of a positioning of the pushing-off elements 10 adapted to the contour of the articles 4, during prepositioning and during ejection. In addition, this dimensioning also determines the minimum spacing of successive articles 4 and thus the capacity of the apparatus 2.

FIG. 2 shows guidance possibilities for the pushing-off elements 10 according to further embodiments. With a groove guidance (FIG. 2a) along the pushing-off line 20, the link element 8 has a slot along the pushing-off line 20 for inserting and guiding the pushing-off element 10 and is guided in a rail-like manner. In particular, in an embodiment of the drive element 12 as a linear motor, the slot is filled by a rail and the pushing-off element 10 is situated on the rotor.

With a gripping guidance (FIG. 2b), the pushing-off element 10 laterally surrounds its link element.

The pushing-off elements 10 can be entirely freely formed and configured and preferably they are designed to be form-fitting with the link elements 8 and/or the articles 4 intended for the apparatus 2.

FIG. 3 shows articles 4a, 4b, 4c lying on a link conveyor with respectively differently positioned pushing-off elements 10 according to further embodiments.

The pushing-off elements 10a are moved to the irregularly shaped article 4a, so that it can be ejected by all the pushing-off elements 10a. A prior change in the orientation by means of individual control of the pushing-off elements 10a is also possible.

The article 4b has been moved by the pushing-off elements 10b as far as the edge 2b of the link conveyor 6 and is oriented along this edge 2b. At a later point in time, the article 4b is laterally ejected—to a terminal 24 or a further conveyor.

The article 4c was surrounded by the pushing-off elements 10c, 10c′ and clamped so that with the link conveyor 6 running fast and during curved travel, the position of the article 4c remains stable. For the surrounding by the pushing-off elements 10c, 10c′, they are either positioned before placement of the article onto the conveying surface on both sides of the link conveyor 6 on the first and second sides 22a, 22b and then moved by contrary movement of the pushing-off elements 10c to the article 4c. For a lateral ejection, a submerging of the pushing-off elements 10c arranged on the ejection side to the height of, or below, the conveying surface 18 is required. This is easily realized in that the pushing-off elements 10 can run round the link element 8. If the pushing-off elements 10 can run round the link element 8 along the pushing-off line 20, a prepositioning of the pushing-off elements 10 before the placement on the link elements 8 is also not required, although it can be advantageous (the prepositioning enables a more rapid positioning of the pushing-off elements 10, etc.).

The pushing-off elements 10 are typically controlled, moved, stopped and/or locked while the link conveyor 6 runs along the belt movement line 16 and the articles 4 can thus be transported along the belt movement line 16. The running speed of the link conveyor 6 can be controlled and adjusted by the control device 14, including stopping of the link conveyor 6.

FIG. 4 shows link elements 8 configured in a scarf joint-like manner according to one embodiment in cross-section. Some of the pushing-off elements 10 are arranged in front, others behind the drawing plane. Due to the scarf joint-like inclines of the link elements 8, the transitions between the link elements 8 do not form any large interfering contours even in the curves, and the conveying surface 18 remains relatively flat. In order that the flexibility of the link conveyor 6 still remains possible, the link elements 8 only overlap one another, but without firm fixing of the contact surfaces of link elements touching one another, since these would make curves and conveyor belt loop-like circulation with upper and lower runs of the link conveyor impossible. Other forms of the interlinking of successive link elements 8 are also possible. Through the overlapping of the link elements 6, no gaps form on the conveying surface, even in curves.

### LIST OF REFERENCE CHARACTERS

2 Apparatus
4 Article
6 Link conveyor
8 Link elements
10 Pushing-off elements
12 Drive elements
14 Control device
16 Belt movement line
18 Conveying surface
20 Pushing-off line
22 Side of the link element
24 Terminal

1-15. (canceled)

16. An apparatus for conveying and sorting articles, comprising:
a link conveyor having link elements, pushing-off elements, drive elements, and a control device;
said link conveyor configured to run along a belt movement line and having said link elements being disposed sequentially one after another along the belt movement line, said link elements forming a conveying surface for the articles;
a pushing-off element of said pushing-off elements being disposed on each of said link elements above said conveying surface so that said pushing-off element runs together with a link element of said link elements along the belt movement line and said pushing-off element being moved and stopped along a pushing-off line disposed on said link element at an angle;
each of said drive elements configured to drive at least one of said pushing-off elements individually, wherein at least two said pushing-off elements being disposed one after another along the belt movement line being driven by different ones of said drive elements so that a movement and stopping of said pushing-off elements disposed one after another is independent of one another; and
said control device configured for controlling a running of said link conveyor and of said drive elements.

17. The apparatus according to claim 16,
wherein said link conveyor having first and second sides; and
further comprising a guide rail, said link elements are mounted on said guide rail disposed between said first and second sides of said link conveyor.

18. The apparatus according to claim 16, wherein said link elements disposed sequentially following one another are disposed behind one another and/or overlapping one another slidingly.

19. The apparatus according to claim 16, wherein said pushing-off elements and said link elements are configured to engage with one another with groove guidance and/or with gripping guidance.

20. The apparatus according to claim 16, wherein said pushing-off elements are configured so they can be lowered to a height of, or, below said conveying surface.

21. The apparatus according to claim 16, wherein said drive elements are linear drives.

22. The apparatus according to claim 16, wherein said pushing-off elements are configured to be lockable.

23. The apparatus according to claim 16, wherein said control device is configured to control the apparatus, said pushing-off elements and the articles.

24. The apparatus according to claim 16, wherein said pushing-off element being moved and stopped along the pushing-off line disposed on said link element substantially perpendicularly to the belt movement line between a first and a second side of said link conveyor.

25. The apparatus according to claim 16,
further comprising a guide rail and said link elements are mounted on said guide rail disposed between first and second sides of the link conveyor substantially centrally; or
further comprising two guide rails and said link elements are mounted laterally on said two guide rails disposed along the belt movement direction.

26. The apparatus according to claim 16, wherein said link elements disposed sequentially following one another are disposed behind one another and/or overlapping one another slidingly in a manner of scarf joints and/or intermeshing with one another.

27. A method for conveying and sorting articles, which further comprises the steps of:
placing an article on at least one link element of a link conveyor having link elements disposed one after another along a belt movement line and forming a conveying surface for the articles, wherein a pushing-off element being disposed above the conveying surface on each of the link elements;
moving the link conveyor along the belt movement line; and
individually controlling a movement and a stoppage of at least one of a plurality of pushing-off elements disposed along each pushing-off line, wherein the pushing-off line being disposed on a respective link element at an angle, and wherein at least two of the pushing-off elements being disposed one after another along the belt movement line being controlled independently of one another.

28. The method according to claim 27, which further comprises:
acquiring a position and/or shape of the article on the conveying surface; and
controlling a running of the link conveyor along the belt movement line and/or of the movement and the stoppage of the pushing-off elements in response to an acquired position and/or shape of the article.

29. The method according to 27, wherein the stoppage of at least one of the pushing-off elements takes place provided the article is still lying on the link element or the link elements of the at least one pushing-off elements.

30. The method according to claim 27, which further comprises applying a contrary motion of the pushing-off elements of successively disposed ones of the link elements to the article lying on the link elements and stopping of the pushing-off elements so that the article is subsequently restricted in its movement by the pushing-off elements.

31. The method according to claim 27, which further comprises moving the article along the pushing-off line by at least one of the pushing-off elements.

32. The method according to claim 27, which further comprises locking of the pushing-off element.

33. The method according to claim 27, which further comprises lowering of the pushing-off element to a height of, or below, the conveying surface.

34. The method according to claim 27, wherein the pushing-off line being disposed on the respective link element substantially perpendicularly to the belt movement line between a first and a second side of the link conveyor.
